(19) United States
(12) Patent Application Publication
(10) Pub. No.: US 2025/0364588 A1
(43) Pub. Date: Nov. 27, 2025

(54) ALL-SOLID-STATE BATTERY, METHOD FOR MANUFACTURING THE SAME, AND POUCH-TYPE ALL-SOLID-STATE BATTERY USING THE SAME

(71) Applicant: UIF (UNIVERSITY INDUSTRY FOUNDATION), YONSEI UNIVERSITY, Seoul (KR)

(72) Inventors: Yoon Seok JUNG, Seoul (KR); Ki Heon BAECK, Seoul (KR); Yong Bae SONG, Seoul (KR)

(73) Assignee: UIF (UNIVERSITY INDUSTRY FOUNDATION), YONSEI UNIVERSITY, Seoul (KR)

(21) Appl. No.: 19/219,433

(22) Filed: May 27, 2025

(30) Foreign Application Priority Data
May 27, 2024 (KR) 10-2024-0068725
May 15, 2025 (KR) 10-2025-0062929

(51) Int. Cl. H01M 10/056; H01M 10/058

(52) U.S. Cl. CPC H01M 10/056; H01M 10/058; H01M 2300/0091

(57) ABSTRACT

The present invention relates to a solid electrolyte film with enhanced mechanical properties through a heat treatment process, a method for manufacturing an all-solid-state battery using the same, and a pouch-type all-solid-state battery, the method comprising: (A) obtaining a solid electrolyte film heat-treated under a gaseous atmosphere; (B) forming a lithium metal anode layer and a cathode layer on opposite surfaces of the heat-treated solid electrolyte film, respectively; (C) manufacturing an all-solid-state battery by performing a single high-pressure process on an assembly comprising the cathode layer, solid electrolyte film, and lithium metal anode layer in that order; wherein, unlike the conventional method requiring two pressing steps when using a lithium metal anode, the present invention enables assembly through a single high-pressure process, while also exhibiting excellent electrochemical performance.

### CROSS-REFERENCE TO RELATED APPLICATIONS

This application claims priority to Korean Patent Application No. 10-2024-0068725 filed on May 27, 2024 and Korean Patent Application No. 10-2025-0062929 filed on May 15, 2025 and all the benefits accruing therefrom under 35 U.S.C. § 119, the contents of which are incorporated by reference in their entirety.

### BACKGROUND

A lithium secondary battery generally comprises a cathode, an electrolyte, and an anode. Conventionally commercialized lithium secondary batteries have a structure in which a polymer separator with a thickness of approximately 20 to 100 μm is added to a liquid electrolyte composed of an organic solvent and a lithium salt. During discharge, lithium ions (Li⁺) move from the anode to the cathode, and electrons generated by the ionization of lithium also flow from the anode to the cathode. During charging, the ions and electrons move in the opposite direction.

The driving force for the movement of lithium ions (Li⁺) is derived from the electrochemical potential difference between the two electrodes. The capacity (Ah) of the battery is determined by the amount of lithium ions (Li⁺) migrating between the electrodes, which depends on the properties of the electrode materials and the contact between the electrodes and the electrolyte.

Since the movement of lithium ions (Li⁺) occurs through the electrolyte, the lithium ion conductivity of the electrolyte significantly affects the charge/discharge rate of the battery. Lithium-ion secondary batteries, a type of rechargeable battery, have advantages such as higher energy density, lower self-discharge rate, and longer lifespan compared to nickel-manganese or nickel-cadmium batteries. However, they also suffer from drawbacks such as thermal stability issues and limited output.

To address the limitations of conventional lithium-ion batteries, all-solid-state batteries have been proposed as a promising alternative. In all-solid-state batteries, the liquid electrolyte is replaced with a solid electrolyte

To increase the energy density of all-solid-state batteries, techniques using lithium metal (Li-metal) as the anode active material have been developed. However, when lithium metal is used as the anode active material, lithium tends to precipitate on the anode during charging. With repeated charge/discharge cycles, lithium dendrites may form by penetrating through the gaps in the solid electrolyte, and such dendrite growth can lead to short-circuiting or capacity degradation of the battery.

Therefore, there is a need for all-solid-state batteries that exhibit excellent electrochemical performance and mechanical properties, even when lithium metal is used as the anode active material.

### SUMMARY

It is an object of the present invention to provide a heat-treated solid electrolyte film comprising a solid electrolyte and a polymer binder, and an all-solid-state battery comprising the same.

Another object of the present invention is to provide a method for manufacturing an all-solid-state battery using the heat-treated solid electrolyte film, wherein the battery can be fabricated through a single high-pressure process.

Yet another object of the present invention is to provide a pouch-type all-solid-state battery including the heat-treated solid electrolyte film.

These and other objects and advantages of the present invention are not limited to those mentioned above, and will become more apparent from the following detailed description. Moreover, it will be readily understood that the objects and advantages of the invention may be realized by means of the features and combinations thereof disclosed herein and in the embodiments of the present invention.

The all-solid-state battery of the present invention includes a heat-treated solid electrolyte film formed from a mixture of a sulfide-based solid electrolyte and a polymer binder. This configuration allows the battery to be manufactured through a single high-pressure process, while also exhibiting excellent electrochemical performance.

According to a conventional method for manufacturing an all-solid-state battery using lithium metal as an anode, internal short-circuiting occurs when a single high-pressure process is applied. Therefore, there was a problem in that the solid electrolyte film had to be pre-pressed to enhance its physical properties before manufacturing the all-solid-state battery. That is, unlike the conventional manufacturing method, in which multiple pressing steps are essential, the all-solid-state battery of the present invention has the advantage that it can be manufactured through a single high-pressure process.

To achieve the above-described objects, the present invention provides an all-solid-state battery comprising a solid electrolyte film including a sulfide-based solid electrolyte and a polymer binder, wherein the solid electrolyte film includes chemical bonding between the sulfide-based solid electrolyte and the polymer binder.

In one embodiment, the chemical bonding may be indicated by a peak detected in the region of 100 to 110 ppm in a ¹³C MAS-NMR spectrum.

In another embodiment, the chemical bonding may be indicated by a peak detected below 398 eV in an X-ray photoelectron spectroscopy (XPS) analysis.

In still another embodiment, the chemical bonding may be formed by heat-treating a solid electrolyte film comprising a sulfide-based solid electrolyte and a polymer binder under an oxygen atmosphere.

In one embodiment, the sulfide-based solid electrolyte may be represented by the following Chemical Formula 1:

(LiₐM¹_{b}M²_{c})(P_{d}M³ₑ)(S_{f}M⁴_{g})Xₕ [Chemical Formula 1]

In Chemical Formula 1:
4≤a≤8;
M¹ is Mg, Cu, Ag, or a combination thereof, and 0≤b<0.5;
M² is Na, K, or a combination thereof, and 0≤c<0.5;
M³ is Sn, Zn, Si, Sb, Ge, or a combination thereof, and 0<d<4, 0≤e<1;
M⁴ is O, SOₙ, or a combination thereof,
1.5≤n≤5, 3≤f≤12, 0≤g<2;
X is F, Cl, Br, I, or a combination thereof, and 0≤h≤2.

In one embodiment, the polymer binder may comprise at least one selected from the group consisting of fluorine-based, diene-based, acryl-based, silicone-based, and rubber-based binders.

In one embodiment, the sulfide-based solid electrolyte and the polymer binder may be mixed in a weight ratio of 1:0.01 to 0.1.

In one embodiment, the all-solid-state battery may be a pouch-type all-solid-state battery.

In one embodiment, the heat treatment may be performed at a temperature of 50 to 150° C. for 30 minutes to 5 hours.

The present invention also provides a method for manufacturing an all-solid-state battery, the method comprising:
(A) preparing a heat-treated solid electrolyte film by heat-treating a solid electrolyte film including a sulfide-based solid electrolyte and a polymer binder under an oxygen atmosphere;
(B) forming an assembly by laminating a lithium metal anode layer and a cathode layer on opposite sides of the solid electrolyte film; and
(C) performing a single high-pressure process on the assembly including the cathode layer, the solid electrolyte film, and the lithium metal anode layer in that order, to manufacture the all-solid-state battery.

In one embodiment, the flow rate of the gas during step (A) may be from 1.0 to 10.0 L/min.

In one embodiment, the single high-pressure process in step (C) may be performed at a pressure of 300 to 500 MPa.

It should be understood that the above-described means for solving the problem are not intended to enumerate all characteristics of the present invention, and various features of the invention may be combined with one another as described in the embodiments of the present specification. Various features, advantages, and effects of the present invention will be more clearly understood from the following detailed description of exemplary embodiments.

### BRIEF DESCRIPTION OF THE DRAWINGS

FIG. 1 is a schematic diagram illustrating the process of manufacturing a pouch-type all-solid-state battery according to Example 1 of the present invention.

FIG. 2 is a schematic diagram illustrating the process of manufacturing a pouch-type all-solid-state battery according to Comparative Example 1.

FIG. 3 is a schematic diagram illustrating the process of manufacturing a pouch-type all-solid-state battery according to Comparative Example 2.

FIG. 4 is a graph showing the ionic conductivity of a heat-treated solid electrolyte film and a non-treated solid electrolyte film according to the present invention.

FIG. 5 is an XRD pattern of a heat-treated solid electrolyte film and a non-treated solid electrolyte film according to the present invention.

FIG. 6 is a graph showing the charge-discharge voltage profile of a first cycle for the all-solid-state battery of Example 1 and that of Comparative Example 1.

FIG. 7 is a graph showing the cycling performance of the all-solid-state battery of Example 1 and that of Comparative Example 2.

FIG. 8 shows the ¹³C MAS-NMR results of the solid electrolyte film of Example 1 and that of Comparative Example 1.

FIG. 9 shows the XPS analysis results of the solid electrolyte film of Example 1 and that of Comparative Example 1.

Unless otherwise clearly indicated by the context, the singular forms used in the present specification shall be understood to include plural forms as well.

As used herein, the term “to” in numerical ranges (e.g., “a to b”) is intended to include both the lower and upper limits of the range. That is, the expression “a to b” should be understood as meaning “a or greater and b or less” (i.e., from a to b, inclusive).

Furthermore, when multiple numerical values are disclosed for the lower and/or upper limits of a given numerical range, it should be understood that all possible combinations of such lower and upper limits are encompassed within the scope of the present disclosure. For example, if the specification discloses “greater than or equal to a or b” and “less than or equal to c or d,” it should be understood to disclose all combinations such as:
a to c, a to d, b to c, and b to d.

The present invention relates to an all-solid-state battery and a pouch-type all-solid-state battery comprising a heat-treated solid electrolyte film formed from a mixture of a sulfide-based solid electrolyte and a polymer binder. The present invention also relates to a method for manufacturing an all-solid-state battery, which, unlike conventional methods, enables fabrication via a single high-pressure process using such a heat-treated solid electrolyte film.

To manufacture an all-solid-state battery with high energy density, it is essential to: (i) use lithium (Li), which has a high theoretical capacity, as the anode material; (ii) adopt a pouch-type all-solid-state battery structure with a thin solid electrolyte film; (iii) implement an efficient assembly process; and (iv) ensure sufficient mechanical properties of the solid electrolyte film to suppress lithium dendrite growth during assembly and operation.

In cases where the anode includes silicon or graphite, a pouch-type all-solid-state battery can be fabricated by applying a single high-pressure process to laminate the cathode, solid electrolyte film, and the silicon or graphite-containing anode. However, when lithium metal is used as the anode, due to its ductile nature, it is difficult to produce a properly functioning pouch-type all-solid-state battery through a single high-pressure process.

Accordingly, in the manufacturing process of pouch-type all-solid-state batteries using lithium metal anodes, a secondary pressing step is essential. This process typically involves a first high-pressure lamination of the cathode and the solid electrolyte film, followed by a second pressing step to attach the lithium metal anode.

Moreover, although the electrodes and the solid electrolyte film require high-pressure lamination to control porosity and reduce interfacial resistance, the lithium metal anode must be pressed at a significantly lower pressure than the first step (often over 450 MPa) due to the soft and ductile nature of lithium metal.

To address these complex manufacturing issues, the present invention provides an all-solid-state battery and a method for manufacturing the same. The battery utilizes a heat-treated solid electrolyte film prepared by thermally treating a mixture of a sulfide-based solid electrolyte and a polymer binder under an oxygen atmosphere, thereby enabling the fabrication of a lithium metal-based all-solid-state battery via a single high-pressure process.

Hereinafter, the present invention will be described in detail.

The present invention provides an all-solid-state battery comprising a solid electrolyte film that includes a sulfide-based solid electrolyte and a polymer binder, wherein the solid electrolyte film comprises chemical bonding between the sulfide-based solid electrolyte and the polymer binder.

### Solid Electrolyte Film

The solid electrolyte film included in the all-solid-state battery of the present invention is prepared by heat-treating a mixture comprising a solid electrolyte and a polymer binder under an oxygen atmosphere.

By employing this solid electrolyte film, the all-solid-state battery can be manufactured through a single high-pressure process.

In particular, the solid electrolyte film included in the all-solid-state battery of the present invention comprises chemical bonding between the sulfide-based solid electrolyte and the polymer binder. As used herein, “chemical bonding between the solid electrolyte and the polymer binder” refers not to a simple physical mixture or adhesion, but to bonding that results from chemical interaction between the two components. Such chemical bonding is confirmed by specific analytical techniques, including X-ray Photoelectron Spectroscopy (XPS) and Nuclear Magnetic Resonance (NMR), as will be described in further detail below.

In one embodiment of the present invention, the chemical bonding between the solid electrolyte and the polymer binder is indicated by the presence of a peak in the region of 100 to 110 ppm in a ¹³C Magic Angle Spinning Nuclear Magnetic Resonance (¹³C MAS-NMR) spectrum.

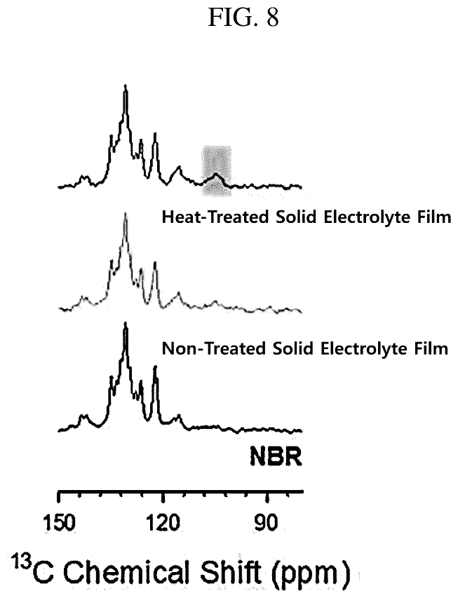

Referring to FIG. 8, a solid electrolyte film prepared by simply mixing a sulfide-based solid electrolyte with a polymer binder (e.g., polyacrylonitrile binder) without heat treatment (Comparative Example 1) does not show a new peak in the 100 to 110 ppm region of the ¹³C MAS-NMR spectrum. In contrast, a solid electrolyte film prepared by mixing a sulfide-based solid electrolyte with a polymer binder and heat-treating the mixture under an oxygen atmosphere (Example 1) exhibits a new peak in 100 to 110 ppm region.

The appearance of a new peak in the ¹³C MAS-NMR spectrum indicates the formation of a new chemical bond involving a carbon atom, suggesting that a chemical interaction (e.g., carbon-oxygen bonding) has occurred between the solid electrolyte and the polymer binder. According to the manufacturing method of the present invention, such bonding is induced by the heat treatment of the mixture under an oxygen atmosphere, which results in the formation of a chemical bond between the solid electrolyte and the polymer binder, as evidenced by the appearance of the new peak in the ¹³C MAS-NMR spectrum.

In another embodiment of the present invention, the chemical bonding between the solid electrolyte and the polymer binder is also evidenced by the appearance of a peak at a binding energy of 398 eV or less in X-ray Photoelectron Spectroscopy (XPS) analysis.

In Comparative Example 1, a solid electrolyte film formed by simply mixing a polymer binder (e.g., polyacrylonitrile binder or NBR) with a sulfide-based solid electrolyte shows a peak around 399 eV in the N Is spectrum, which corresponds to a weak interaction between nitrogen atoms of the binder and the solid electrolyte.

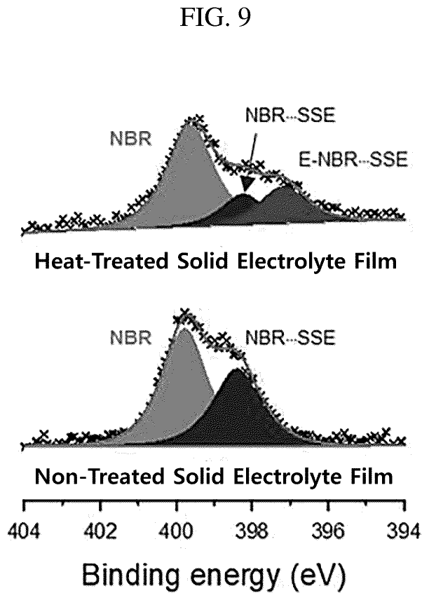

However, as shown in FIG. 9, the solid electrolyte film of Example 1—prepared by mixing the same materials and performing heat treatment under an oxygen atmosphere—exhibits a new peak at below 398 eV in the N Is spectrum. The appearance of this new peak in the XPS spectrum indicates the formation of a new chemical bond with a different binding energy, which confirms the occurrence of chemical bonding between the binder and the solid electrolyte.

It is believed that the mechanical properties of the solid electrolyte film are improved by the new chemical bonding in the sulfide-based solid electrolyte.

The solid electrolyte of the present invention may be a sulfide-based solid electrolyte and may be represented by the following Chemical Formula 1:

(LiₐM¹_{b}M²_{c})(P_{d}M³ₑ)(S_{f}M⁴_{g})Xₕ [Chemical Formula 1]

In Chemical Formula 1:
4≤a≤8;
M¹ is Mg, Cu, Ag, or a combination thereof, and 0≤b<0.5;
M² is Na, K, or a combination thereof, and 0≤c<0.5;
M³ is Sn, Zn, Si, Sb, Ge, or a combination thereof, and 0<d<4, 0≤e<1;
M⁴ is O, SOₙ, or a combination thereof,
1.5≤n≤5, 3≤f≤12, 0≤g<2;
X is F, Cl, Br, I, or a combination thereof, and 0≤h≤2.

In one example, the halide element X is essentially included, in which case h is greater than 0 and less than or equal to 2 (0<h≤2). In another example, M¹ is necessarily included, in which case b is greater than 0 and less than 0.5 (0<b<0.5). M³ may be understood as a substituent for P, and in such case, e is greater than 0 and less than 1 (0<e<1). M⁴ may be substituted for S, and g may be greater than 0 and less than 2 (0<g<2). The sulfur ratio f may range, for example, from 3 to 7 (3≤f≤7).

In the case where M⁴ is SOₙ, SOₙ may include, for example, S₄O₆, S₃O₆, S₂O₃, S₂O₄, S₂O₅, S₂O₆, S₂O₇, S₂O₈, SO₄, or SO₅, and preferably SO₄.

In one embodiment, the stoichiometric relationship may satisfy:

a+b+c+h=7,

d+e=1, and

f+g+h=6.

Specific examples of argyrodite-type sulfide-based solid electrolytes may include, but are not limited to: Li₃PS₄, Li₇P₃S₁₁, Li₇PS₆, Li₆PS₅Cl(LPSCl), Li₆PS₅Br, Li_{5.8}PS_{4.8}C_{l1.2}, Li_{6.2}PS_{5.2}Br_{0.8}, Li_{5.75}PS_{4.75}C_{l1.25}, (Li_{5.69}Cu_{0.06}) PS_{4.75}Cl_{1.25}, (Li_{5.72}Cu_{0.03}) PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25} and Li_{5.75}P(S_{4.725}(SO₄)_{0.025})Cl_{1.25}, or combinations thereof.

In one embodiment of the present invention, the polymer binder may comprise at least one selected from the group consisting of fluorine-based, diene-based, acryl-based, silicone-based, and rubber-based binders. Preferably, the binder may be rubber-based, and more preferably, it may include nitrile butadiene rubber (NBR).

In one embodiment, the sulfide-based solid electrolyte and the polymer binder may be mixed in a weight ratio of 1:0.01 to 0.1, preferably 1:0.03 to 0.05. When the binder content falls outside this range based on the weight of the sulfide-based solid electrolyte, the mechanical strength of the solid electrolyte film may deteriorate, or the ionic conductivity may be significantly reduced.

In one embodiment, the solid electrolyte film may be heat-treated under an oxygen atmosphere. When an inert gas such as helium or argon is used instead of oxygen, lithium may penetrate the unregulated pores of the film and cause internal short-circuiting. In the case of nitrogen, undesirable side reactions with the sulfide-based solid electrolyte may occur.

The flow rate of the oxygen gas supplied may be from 1.0 to 10.0 L/min, preferably from 2.0 to 5.0 L/min, and more preferably from 2.0 to 3.0 L/min. If the gas flow rate is outside the above range, a single high-pressure process may not be feasible. For example, when the oxygen flow rate is less than 1.0 L/min, sufficient oxygen may not be supplied, making it impossible to enhance the mechanical properties of the solid electrolyte film. On the other hand, when the oxygen flow rate exceeds 10.0 L/min, the gas velocity may become too high to maintain a stable temperature, thereby also making it impossible to enhance the mechanical properties of the solid electrolyte film.

The oxygen gas used for heat treatment may have a purity of at least 99.9%, preferably 99.99%, 99.999%, or 99.9999%.

In one embodiment, the heat treatment may be carried out at a temperature of 50 to 150° C., preferably 60 to 130° C., and more preferably 60 to 110° C., for a duration of 30 minutes to 5 hours, preferably 50 minutes to 4 hours, and more preferably 1 to 3 hours. If the heat treatment temperature is below 50° C., fabrication through a single high-pressure process may become infeasible. Conversely, if the temperature exceeds 150° C., the all-solid-state battery may not operate properly. In addition, when the heat treatment time is less than 30 minutes, it may not be possible to fabricate the product through a single high-pressure process alone. Conversely, when the heat treatment time exceeds 5 hours, deformation of the solid electrolyte layer may occur, making it impossible to obtain an all-solid-state battery with the desired performance.

In one embodiment, the ionic conductivity of the solid electrolyte film may range from 0.40 to 3.0 mS/cm, preferably 0.7 to 2.0 mS/cm, and more preferably 0.8 to 1.5 mS/cm. When the ionic conductivity falls below 0.40 mS/cm, it may hinder the operation of the all-solid-state battery due to insufficient ion conductivity.

The solid electrolyte film of the present invention may be fabricated by applying a slurry comprising the sulfide-based solid electrolyte, polymer binder, and a solvent, followed by a heat treatment step. The solvent is not particularly limited as long as it is nonpolar and capable of dispersing the solid electrolyte and binder. Preferably, the solvent may include at least one selected from the group consisting of benzyl acetate, xylene, toluene, and butyl butyrate.

The thickness of the solid electrolyte film may range from 10 to 50 μm, and preferably from 30 to 50 μm.

### Method for Manufacturing All-Solid-State Battery

In one embodiment, the method for manufacturing an all-solid-state battery according to the present invention includes the following steps:
(A) preparing a heat-treated solid electrolyte film under an oxygen atmosphere;
(B) laminating a lithium metal anode layer and a cathode layer on both sides of the heat-treated solid electrolyte film and
(C) applying a single high-pressure process to an assembly comprising the cathode layer, the solid electrolyte film, and the lithium metal anode layer in that order, to fabricate the all-solid-state battery.

In step (A), the solid electrolyte film is first obtained by heat treatment in an oxygen atmosphere, ensuring that it can withstand a single high-pressure fabrication process. In step (B), a lithium metal anode layer and a cathode layer are respectively laminated on both sides of the heat-treated solid electrolyte film. Specifically, the cathode layer is formed on the upper surface of the heat-treated solid electrolyte film, and the lithium metal anode layer is formed on the lower surface of the heat-treated solid electrolyte film, such that the cathode layer, the solid electrolyte film, and the lithium metal anode layer are arranged in that order.

The cathode layer and the lithium metal anode layer will be described in more detail below. Next, in step (C), a single high-pressure process is performed on an assembly comprising the cathode layer, the solid electrolyte film, and the lithium metal anode layer, in that order, to manufacture the all-solid-state battery. In conventional manufacturing processes using a lithium metal anode layer as the anode, two separate pressing steps are required to fabricate the final all-solid-state battery. In the first pressing step, a pressure of 450 MPa or higher is applied to bond the cathode and the solid electrolyte film. In the second pressing step, a lower pressure of 100 MPa is applied to bond the solid electrolyte film with the lithium metal anode layer. However, in the present invention, the all-solid-state battery is manufactured through a single high-pressure process by applying a pressure of 300 to 500 MPa, preferably 350 to 450 MPa, and more preferably 400 to 450 MPa, to the assembly comprising the cathode layer, the solid electrolyte film, and the lithium metal anode layer, in that order.

In the present invention, by using a solid electrolyte film whose mechanical properties have been enhanced through a heat treatment process, a high-pressure pressing process can be performed while employing a lithium metal anode layer. As a result, even if the soft lithium metal penetrates into the porous solid electrolyte film, the solid electrolyte film is not damaged. That is, since the solid electrolyte film is not damaged even under high-pressure pressing, it is possible to manufacture the all-solid-state battery through a single high-pressure process.

If the pressure is below 300 MPa, overpotential may occur during operation; if it exceeds 500 MPa, structural damage may be caused to the film, cathode, or anode, preventing proper battery operation.

Specifically, although not explicitly described in the following Examples or Comparative Examples, the all-solid-state battery manufactured according to the method of the present invention exhibits high charge/discharge capacity and Coulombic efficiency, shows no delamination or cracking phenomena, and can have an extended cyclability.

The all-solid-state battery exhibiting the above-mentioned effects may preferably be manufactured by: heat-treating a solid electrolyte film under an oxygen atmosphere at a flow rate of 1.0 to 10.0 L/min, at a temperature of 90 to 120° C. for 1 to 5 hours, to obtain a solid electrolyte film having an ionic conductivity of 0.80 to 0.87 mS/cm; providing a lithium metal anode layer and a cathode layer on opposite sides of the heat-treated solid electrolyte film; and subjecting an assembly comprising the cathode layer, the solid electrolyte film, and the lithium metal anode layer, in that order, to a single pressing process at a pressure of 300 to 500 MPa. In addition, the present invention provides an all-solid-state battery comprising a solid electrolyte film that has been heat-treated under a gaseous atmosphere.

The all-solid-state battery according to the present invention comprises a cathode layer, a lithium metal anode layer, and a solid electrolyte film interposed therebetween. The battery is preferably a pouch-type secondary battery having a discharge capacity of 150 to 200 mAh/g at 0.2 C and an initial coulombic efficiency (ICE) of 80 to 99%, more preferably 80 to 85%. The cathode layer includes a lithium-containing metal oxide as a cathode active material capable of lithium ion insertion and extraction via redox reactions, and may further include at least one of a solid electrolyte, a conductive additive, and a binder. Suitable conductive additives include graphene, carbon nanotubes, Ketjen black, activated carbon, Super P carbon, Denka carbon, and vapor-grown carbon fiber (VGCF). The binder may be a polymer compound selected from fluorine-based, diene-based, acrylic-based, and silicone-based materials, preferably nitrile butadiene rubber (NBR). The cathode layer may be formed by coating a slurry containing at least one of the aforementioned components, and preferably has a thickness of 50 to 200 μm. The anode layer comprises a lithium metal foil, preferably with a thickness of 10 to 100 μm.

The lithium metal anode layer may be manufactured in the form of a metal foil rolled onto a current collector. The thickness of the anode layer is preferably, for example, from 10 to 100 μm.

The solid electrolyte film is formed between the cathode layer and the anode layer and is prepared according to the method of the present invention.

The all-solid-state battery may further include a cathode current collector for collecting current from the cathode layer and an anode current collector for collecting current from the anode layer.

Examples of materials for the cathode current collector include SUS (stainless steel), aluminum, nickel, iron, titanium, and carbon, with aluminum being preferred. Meanwhile, examples of materials for the anode current collector include SUS, copper, nickel, and carbon, with SUS being preferred. The thickness, shape, and other characteristics of the cathode and anode current collectors may be appropriately selected depending on the intended use of the battery.

The all-solid-state battery may further include a battery case for housing the components. The battery case may be a conventional battery case, and preferably may be made of SUS.

The all-solid-state battery according to the present invention may be either a primary battery or a secondary battery, with a secondary battery being preferred due to its suitability for repeated charge/discharge cycles, such as in electric vehicle applications.

The following examples are provided to aid understanding of the present invention, but are intended for illustrative purposes only. It will be apparent to those skilled in the art that various modifications and changes can be made without departing from the spirit and scope of the invention, which is defined by the appended claims.

### Example 1: Heat-Treated Solid Electrolyte Film and Single High-Pressure Process

### Heat-Treated Solid Electrolyte Film

A sulfide-based slurry was prepared by mixing 48.5 wt % of Li₆PS₅Cl, 1.5 wt % of nitrile butadiene rubber (NBR), and 50 wt % of benzyl acetate. The slurry was coated onto a substrate to form a solid electrolyte film. The film was then placed in a furnace, and oxygen gas was supplied at a flow rate of 2.5 L/min. Heat treatment was performed at 60° C. for 3 hours to obtain the final solid electrolyte film (film).

### All-Solid-State Battery

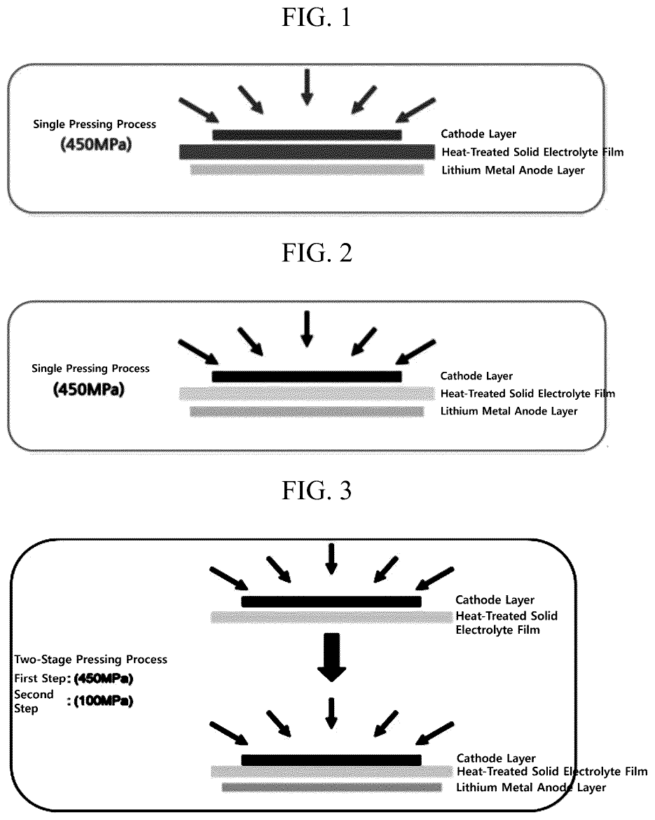

A cathode layer was formed on the upper surface of the heat-treated solid electrolyte film, and a lithium metal anode layer was formed on the lower surface. A single pressing step was then performed by applying a pressure of 450 MPa from the cathode side, resulting in the fabrication of a pouch-type all-solid-state battery (see FIG. 1).

### Comparative Example 1: Untreated Solid Electrolyte Film-Single High-Pressure Process

A pouch-type all-solid-state battery was fabricated in the same manner as in Example 1, except that a non-heat-treated sulfide-based solid electrolyte film (hereinafter referred to as “untreated solid electrolyte film”) was used instead of the heat-treated solid electrolyte film (see FIG. 2).

### Comparative Example 2: Untreated Solid Electrolyte Film-Multiple Pressing Process

A cathode layer was first formed on the untreated sulfide-based solid electrolyte film (as used in Comparative Example 1), followed by a pressing process at 450 MPa to bond the layers. Subsequently, a lithium metal anode layer was formed on the opposite side of the solid electrolyte film, and an additional pressing process at 100 MPa was carried out to fabricate a pouch-type all-solid-state battery (see FIG. 3).

### TEST EXAMPLE

### Test Example 1: EIS Measurement of Solid Electrolyte Films

The ionic conductivity of the heat-treated solid electrolyte film from Example 1 and the untreated solid electrolyte films from Comparative Examples 1 and 2 was measured using Electrochemical Impedance Spectroscopy (EIS) (VSP-300, Neoscience Co., Ltd.).

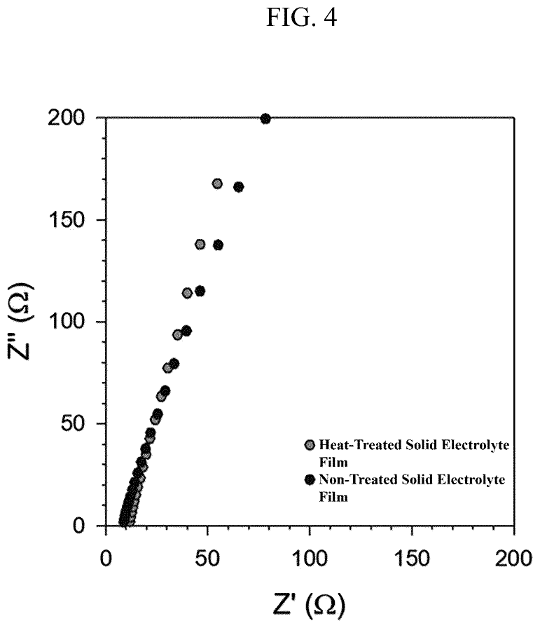

FIG. 4 is a graph showing the ionic conductivity of the heat-treated solid electrolyte film from Example 1 and the untreated film from Comparative Example 1.

As shown in FIG. 4, the ionic conductivity of the untreated solid electrolyte film was measured to be 0.88 mS/cm, while the heat-treated solid electrolyte film exhibited an ionic conductivity of 0.84 mS/cm, confirming that the heat treatment process under an oxygen atmosphere has minimal effect on ionic conductivity.

### Test Example 2: XRD Measurement of Solid Electrolyte Films

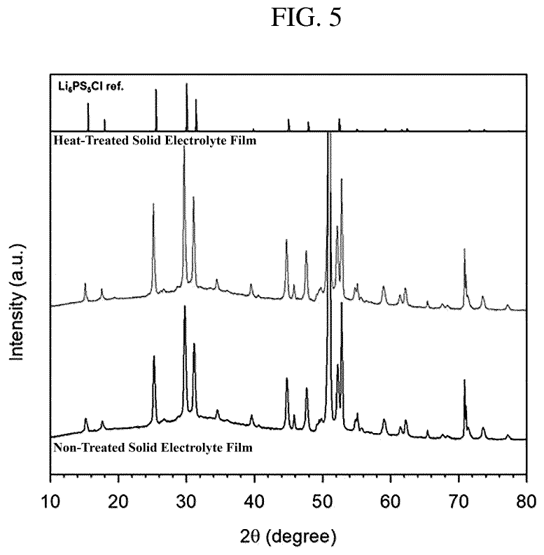

X-ray diffraction (XRD) analysis was performed on the heat-treated solid electrolyte film of Example 1 and the untreated solid electrolyte films of Comparative Examples 1 and 2. The results are shown in FIG. 5. The XRD patterns were obtained using a Rigaku MiniFlex600 diffractometer with Cu Kα radiation (λ=1.5406 Å). The XRD cell containing the sample was mounted on the diffractometer, and measurements were carried out under conditions of 40 kV and 15 mA.

As shown in FIG. 5, no significant difference was observed in the crystallization patterns between the heat-treated solid electrolyte film of Example 1 and the untreated films of Comparative Examples 1 and 2.

### Test Example 3: Performance Evaluation of Full all-Solid-State Cells

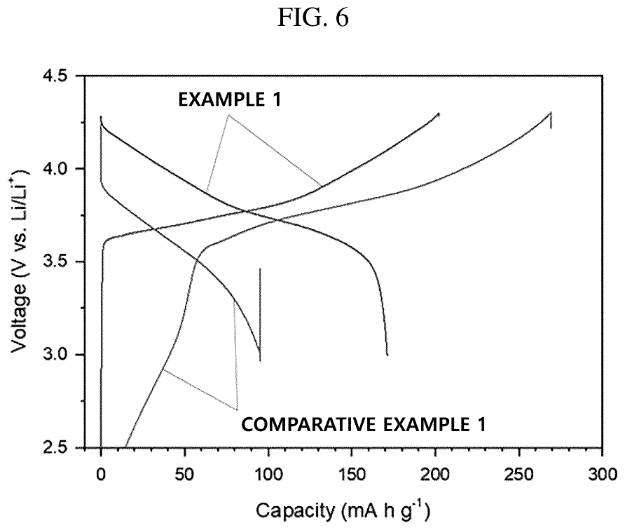

FIG. 6 shows the charge-discharge voltage profiles during the first cycle (at 0.2 C and 60° C.) for the all-solid-state batteries of Example 1 and Comparative Example 1.

As shown in FIG. 6, the battery of Example 1 exhibited a normal charge-discharge curve profile, whereas the battery of Comparative Example 1 exhibited an irregular charge-discharge curve, indicating abnormal operation.

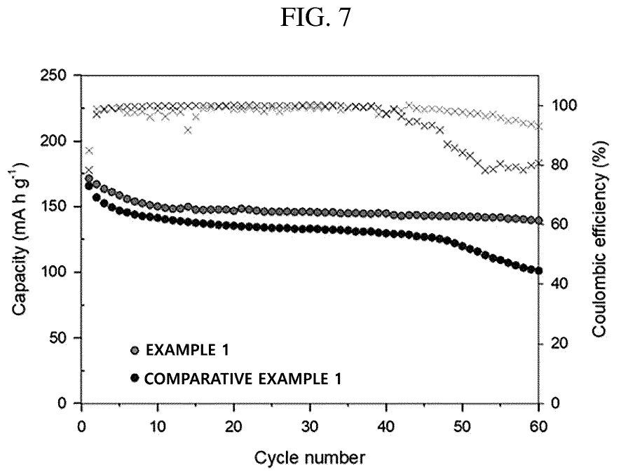

FIG. 7 illustrates the cycling performance of the all-solid-state batteries from Example 1 and Comparative Example 2 under the same conditions (0.2 C at 60° C.).

As shown in FIG. 7, the battery of Example 1 maintained excellent cycle life with no significant capacity fading across all cycles. In contrast, the battery of Comparative Example 2 exhibited a marked decline in capacity after 50 cycles.

### Test Example 4: ¹³C MAS-NMR Measurement

FIG. 8 shows the results of ¹³C MAS-NMR measurements performed on the solid electrolyte films fabricated in Example 1 and Comparative Example 1.

The NMR experiments were conducted using a Varian 600 MHz FT-NMR spectrometer equipped with an HXY fast MAS solid probe, available at the UNIST Central Research Facilities.

Specifically, the NMR samples were sealed in 1.6 mm ZrO₂ rotors and spun at a rate of 35 kHz. The ¹³C direct polarization (DP) MAS spectra were obtained at a resonance frequency of 150.84 MHZ, and the chemical shifts were referenced to hexamethylbenzene, calibrated at 17.3 ppm.

The detailed experimental conditions were as follows:
Pulse length: 1.5 μs
Number of scans: 6,144
Recycle delay: 10 seconds

As shown in FIG. 8, it can be confirmed that a new peak appears at around 105 ppm in the solid electrolyte film manufactured according to Example 1 of the present invention. This peak was not observed in the solid electrolyte film of Comparative Example 1 or in the NBR binder alone, indicating that a strong chemical bond was formed between the polymer binder and the sulfide-based solid electrolyte as a result of the manufacturing method of the present invention.

### Test Example 5: X-ray Photoelectron Spectroscopy (XPS) Measurement

FIG. 9 shows the results of X-ray photoelectron spectroscopy (XPS) analysis performed on the solid electrolyte films prepared in Example 1 and Comparative Example 1.

The XPS measurements were conducted using a K-Alpha+ spectrometer (Thermo Fisher Scientific) with a monochromatic Al Kα X-ray source (photon energy: 1486.6 eV), under conditions of 12 kV and 6 mA.

As shown in FIG. 9, the solid electrolyte film fabricated in Example 1 exhibited a decrease in the peak at approximately 399 eV and the emergence of a new peak at a lower binding energy—specifically around 397 eV.

Referring to FIG. 9, it can be confirmed that, in the solid electrolyte film manufactured according to Example 1 of the present invention, the peak around 399 eV decreases and a new peak is formed in the region below 398 eV, specifically around 397 eV. The peak at approximately 399 eV corresponds to the interaction between the binder polymer and the sulfide-based polymer, whereas the peak around 397 eV corresponds to a chemical bond between the polymer binder and the sulfide-based solid electrolyte.

This peak was not observed in the solid electrolyte film of Comparative Example 1 or in the NBR binder alone, indicating that a strong chemical bond was formed between the polymer binder and the sulfide-based solid electrolyte as a result of the manufacturing method of the present invention.

According to the method for manufacturing an all-solid-state battery of the present invention, it was confirmed that a new chemical bond is formed between the polymer binder and the sulfide-based solid electrolyte. As a result, the electrochemical performance of the all-solid-state battery is significantly improved.

This improvement is believed to result from the formation of the new chemical bond between the polymer binder and the sulfide-based solid electrolyte, which enhances the mechanical properties of the solid electrolyte film. Accordingly, a key advantage of the present invention is that an all-solid-state battery comprising a lithium metal anode layer can be manufactured via a single high-pressure process.

The features described in the above-described embodiment may be combined with other embodiments, unless expressly stated otherwise. Although preferred embodiments of the present invention have been described in detail above, the scope of the present invention is not limited thereto. Various modifications and alterations that can be made by those skilled in the art, based on the basic concept defined in the following claims, also fall within the scope of the present invention.

What is claimed is:

1. An all-solid-state battery comprising a solid electrolyte layer,
the solid electrolyte layer comprising:
a sulfide-based solid electrolyte; and
a polymer binder,
wherein the solid electrolyte layer comprises a chemical bond between the sulfide-based solid electrolyte and the polymer binder.

2. The all-solid-state battery of claim 1, wherein the chemical bond refers that a peak appears in a range of 100 to 110 ppm, as analyzed using ¹³C magic angle spinning-nuclear magnetic resonance (MAS-NMR).

3. The all-solid-state battery of claim 1, wherein the chemical bond refers that a peak appears at 398 eV or less, as analyzed using XPS.

4. The all-solid-state battery of claim 1, wherein the chemical bond is formed by heat-treating the solid electrolyte layer which comprises a sulfide-based solid electrolyte, and a polymer binder in an oxygen atmosphere.

5. The all-solid-state battery of claim 1, wherein the sulfide-based solid electrolyte is represented by Formula 1 below:
(LiₐM¹_{b}M²_{c})(P_{d}M³ₑ)(S_{f}M⁴_{g})Xₕ [Formula 1]
where, in Formula 1 above, 4≤a≤8, M¹ is Mg, Cu, Ag, or a combination thereof, 0≤b<0.5, M² is Na, K, or a combination thereof, 0≤c<0.5, M³ is Sn, Zn, Si, Sb, Ge, or a combination thereof, 0<d<4, 0≤e<1, M⁴ is O, SOₙ, or a combination thereof, 1.5≤n≤5, 3≤f≤12, 0≤g<2, X is F, Cl, Br, I, or a combination thereof, and 0≤h≤2.

6. The all-solid-state battery of claim 1, wherein the polymer binder is one or more selected from the group consisting of a fluorine-based binder, a diene-based binder, an acryl-based binder, a silicon-based binder, and a rubber-based binder.

7. The all-solid-state battery of claim 1, wherein the sulfide-based solid electrolyte and the polymer binder are mixed at a weight ratio of approximately 1:0.01-0.1.

8. The all-solid-state battery of claim 1, wherein the all-solid-state electrolyte battery is a pouch-type all-solid-state battery.

9. The all-solid-state battery of claim 4, wherein the heat treatment is performed at 50 to 150° C. for 30 minutes to 5 hours.

10. A method for manufacturing the all-solid-state battery of claim 1, the method comprising:
(A) performing a heat treatment on a solid electrolyte layer comprising a sulfide-based solid electrolyte, and a polymer binder in an oxygen atmosphere to prepare a solid electrolyte layer;
(B) stacking a lithium metal negative electrode layer and a positive electrode layer on both sides of the solid electrolyte layer, respectively, to manufacture an assembly; and
(C) performing a single high-pressure process on the assembly in which the positive electrode layer, the solid electrolyte layer, and the lithium metal negative electrode layer are provided in the order listed to manufacture an all-solid-state battery.

11. The method for manufacturing an all-solid-state battery of claim 10, wherein the flow rate of gas in the step (A) is 1.0 to a 10.0 L/min.

12. The method for manufacturing an all-solid-state battery of claim 11, wherein the single high-pressure process in the step (C) is performed at a pressure of 300 to 500 MPa.

13. The method for manufacturing an all-solid-state battery of claim 11, wherein the heat treatment in the step (A) is performed at 50 to 150° C. for 30 minutes to 5 hours.
